(19) United States
(12) Patent Application Publication
(10) Pub. No.: US 2024/0335065 A1
(43) Pub. Date: Oct. 10, 2024

(54) HEIGHT-ADJUSTABLE BAKING DEVICE

(71) Applicant: Tsann Kuen (Zhangzhou) Enterprise Co., Ltd., Zhanzhou City (CN)

(72) Inventor: Chunyu WU, Zhangzhou City (CN)

(21) Appl. No.: 18/417,332

(22) Filed: Jan. 19, 2024

(30) Foreign Application Priority Data
Apr. 8, 2023 (CN) 202320762180.1

(51) Int. Cl. A47J 37/06

(52) U.S. Cl. CPC A47J 37/0611; A47J 2037/0617

(57) ABSTRACT

The present invention provides a height-adjustable baking device, including a first grill unit and a second grill unit. The second grill unit includes a second housing, a second baking plate, a connecting column and an adjusting member. A first end portion of the connecting column is connected with the second baking plate. A second end portion of the connecting column is screwed with the second housing, and the connecting column is movable relative to the second housing along a vertical rotation direction. The adjusting member is arranged on the second housing and engaged with a tail end of the second end portion of the connecting column, so that the connecting column drives the second baking plate to move up or down by a height relative to the second housing.

### CROSS-REFERENCE TO RELATED APPLICATIONS

This application claims priority to Chinese Patent Application 202320762180.1, filed on Apr. 8, 2023, which is incorporated herein by reference.

### TECHNICAL FIELD

The present invention relates to the field of kitchen utensils, and more specifically relates to a baking device product.

### BACKGROUND

Waffles, a popular snack in many countries, are typically divided into two types: Croquant waffles, which are about 15 mm thick and taste hard and crisp, and Belgium waffles, which are about 25 mm thick and taste soft and fluffy. In order to satisfy different ways of eating, there are highly different designs of waffle baking device products in the market.

For manufacturers, producing different types of baking device products undoubtedly increases manufacturing costs. Therefore, in the prior art, Patent Publication No. CN212140207U discloses a waffle maker, including a collar combination arranged between an upper baking pan and a lower baking pan. When making a waffle, the thickness can be adjusted according to whether the collar combination is used or not. However, this waffle maker has a fixed adjustable height because of the limitation of the collar combination, and it is also inconvenient to store.

In addition, Patent Publication No. CN211380923U discloses a baking device with a lifting baking pan, including a base which is provided with a lower baking pan with a lifting assembly. The lifting assembly includes fixed mounts, connecting shafts, connecting pieces and a spring. The lower baking pan is driven by the lifting assembly to move up or down, so as to rise and fall according to the thickness of food. However, this baking device is not only troublesome to assemble because of its very complicated structure, but also laborious to use due to the structural design.

Therefore, it is necessary to improve the prior art.

### SUMMARY

In view of the above problems, the present invention provides a height-adjustable baking device, which is not only suitable for baking food with different thicknesses, but also solves the problem that the baking device in the prior art is troublesome to assemble and laborious to use.

In order to achieve the above objective, the present invention adopts the following technical solution:

A height-adjustable baking device includes a first grill unit and a second grill unit pivoted to the first grill unit. The second grill unit includes a second housing, a second baking plate movably mounted in the second housing and facing the first grill unit, a connecting column and an adjusting member.

A first end portion of the connecting column is connected with the second baking plate, so that relative positions between the connecting column and the second baking plate remain unchanged. A second end portion of the connecting column is screwed with the second housing, and the connecting column is movable relative to the second housing along a vertical rotation direction. The adjusting member is arranged on the second housing and engaged with a tail end of the second end portion of the connecting column.

The consumer may adjust a position of the adjusting member according to the thickness of food to be baked. The connecting column is controlled to rotate through the adjusting member, so that the connecting column drives the second baking plate to move up or down by a height relative to the second housing. The height of the present invention is a distance between a surface of the first baking plate and a surface of the second baking plate, but is not limited thereto in the present invention.

Further, the second end portion of the connecting column is screwed with the second housing through thread grooves and thread ridges. Preferably, an outer surface of the second end portion of the connecting column is provided with the thread ridges; and the second housing is provided with a fixing member forming a hollow sleeve, and an inner surface of the sleeve of the fixing member is provided with the thread grooves. When the adjusting member drives the connecting column to rotate clockwise or counterclockwise, the connecting column moves up or down along a screwing track of the thread grooves and the thread ridges. Since one end of the connecting column is fixedly connected with the second baking plate, the second baking plate also moves up or down relative to the second housing.

Further, a side of the second baking plate facing away from the first grill unit may be provided with a snap-fit member, and the first end portion of the connecting column is movably connected with the snap-fit member. If the surface of the first baking plate and the surface of the second baking plate are designed with specific patterns, the positions of the surfaces of the baking pans can be prevented from changing due to rotation in the moving up or down process.

Alternatively, the first end portion of the connecting column may be fixedly connected with the second baking plate. The pattern on the surface of the second baking plate may be in axial symmetry or central symmetry. Preferably, when the pattern on the surface of the second baking plate is in axial symmetry and the adjusting member drives the connecting column to rotate by 180°, the second baking plate moves up or down by the height relative to the second housing. Additionally, when the pattern on the surface of the second baking plate is in central symmetry and the adjusting member drives the connecting column to rotate by 90°, the second baking plate moves up or down by the height relative to the second housing. Thereby, when in use, although the baking thickness may be different, the positions of the patterns of the baking pans are kept consistent.

Further, the first grill unit includes a first housing, and a first baking plate fixedly mounted on an inner side of the first housing and facing the second grill unit, and a periphery of the first baking plate is provided with a side wall, so that the first baking plate and the second baking plate form a baking space. Thereby, the baking thickness of the baking device of the present invention may depend on the distance between the first baking plate and the second baking plate after the second baking plate moves up or down. In addition, in order to prevent food from spillover through the gap between the two baking pans, a surface and a peripheral side wall of the first baking plate form a room that allows the second baking plate to move up or down, so that the surface of the first baking plate and the surface of the second baking plate form the baking space. Preferably, a height of the side wall is equal to the height by which the second baking plate moves up or down.

Further, the adjusting member may be a knob or an adjusting arm. Preferably, the knob includes a connecting hole, the connecting hole has a depth equal to the height and has a same shape as a cross section of the tail end of the second end portion of the connecting column, and the tail end of the second end portion of the connecting column is inserted into and engaged with the connecting hole. Alternatively, the adjusting member is an adjusting arm extending from the connecting column out of the second housing along any direction, and relative side of the second housing are provided with a rail grooves. Preferably, the adjusting arm extends from the connecting column perpendicularly out of a side of the second housing. Both the knob and the adjusting arm can greatly reduce the difficulty of operating the baking device of the present invention, which is convenient for the user to apply force.

The present invention has the following beneficial effects:

With this structure, the baking pan can be moved up or down by simply adjusting the adjusting arm or the knob according to different thicknesses of food to be baked. Moreover, the baking device of the present invention is easy to assemble, which greatly reduces the defective rate of production, and is easy to operate for consumers.

### BRIEF DESCRIPTION OF DRAWINGS

FIG. 1 is a three-dimensional view of a baking device according to a first example of the present invention;

FIG. 2 is a structural exploded view of the baking device according to the first example of the present invention;

FIG. 3 is a schematic view of the baking device in which the second baking plate is moved up according to the present invention;

FIG. 4 is a schematic view of the baking device in which the second baking plate is moved down according to the present invention; and

FIG. 5 is a three-dimensional view of a baking device according to a second example of the present invention.

1—baking device; 11—first grill unit; 12—second grill unit; 121—second housing; 122—second baking plate; 1221—snap-fit member; 123—connecting column; 1241—fixing member; 125—knob; 1243—adjusting arm; 111—first housing; 112—first baking plate; 1121—side wall.

### DESCRIPTION OF EMBODIMENTS

The technical solutions of the present invention will be described in detail below with reference to the accompanying drawings and the examples.

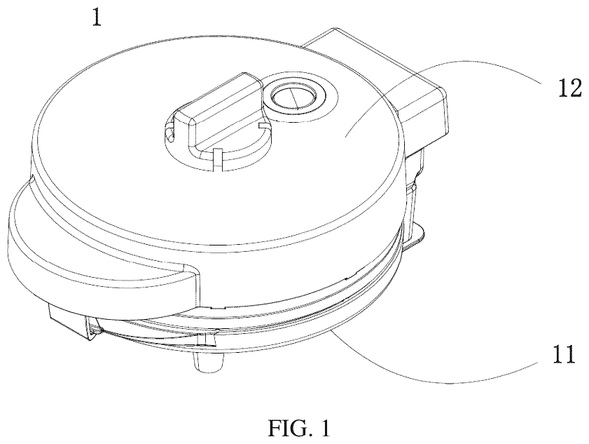

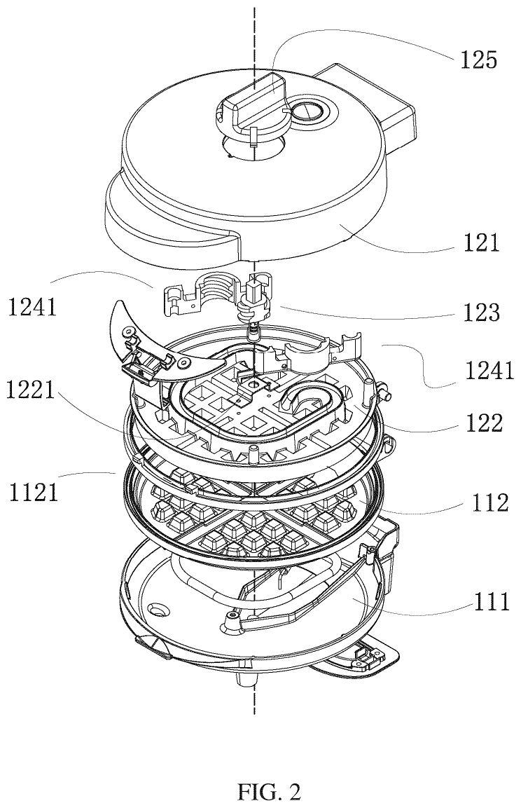

According to a first example shown in FIG. 1 and FIG. 2, the present invention provides a height-adjustable baking device 1, including a first grill unit 11 and a second grill unit 12 pivoted to the first grill unit 11. In this example, the first grill unit 11 is an upper baking seat, and the second grill unit 12 is a lower baking seat. By means of pivoting, the upper baking seat is openable and closable relative to the lower baking seat along an angular direction.

The second grill unit 12 includes a second housing 121, a second baking plate 122 movably mounted in the second housing 121 and facing the first grill unit 11, a connecting column 123 and an adjusting member.

A first end portion of the connecting column 123 is connected with the second baking plate 122 by means of locking or other fixed connections or snap-fit or other movable connections, which is not limited thereto, so that relative positions between the connecting column 123 and the second baking plate 122 remain unchanged. In this example, a side of the second baking plate 122 facing away from the first grill unit 11 is provided with a snap-fit member 1221. The first end portion of the connecting column 123 runs through the snap-fit member 1221 from one side, the connecting column 123 is locked by the other side of the snap-fit member, and then the snap-fit member 1221 is locked to the second baking plate 122. In this way, the relative positions of the connecting column 123 and the second baking plate 122 remain unchanged, but they are allowed to rotate relatively, which prevents the positions of the surfaces of the baking pans from changing due to rotation in the moving up or down process.

A second end portion of the connecting column 123 is screwed with the second housing 121, and the connecting column 123 is movable relative to the second housing 121 along a vertical rotation direction. Preferably, the second end portion of the connecting column 123 is screwed with the second housing 121 through thread grooves and thread ridges. In this example, an outer surface of the second end portion of the connecting column 123 is provided with the thread ridges, and the second housing 121 is provided with a fixing member 1241 forming a hollow sleeve. The fixing member 1241 may be formed by two components to lock the second housing 121, or may be formed by extending from the second housing 121 to the second baking plate 122. An inner surface of the sleeve of the fixing member 1241 is provided with the thread grooves. Thereby, the connecting column 123 can be screwed with the fixing member along a screwing track of the thread grooves and the thread ridges, and can move relative to the second housing 121 along the vertical rotation direction.

Additionally, when in use, although the baking thickness may be different, the positions of the patterns of the baking pans are kept consistent. If the first end portion of the connecting column 123 is fixedly connected with the second baking plate 122, when a pattern on a surface of the second baking plate 122 is in axial symmetry and the adjusting member drives the connecting column 123 to rotate by 180°, the second baking plate 122 moves up or down by the height relative to the second housing 121; and when the pattern on the surface of the second baking plate 122 is in central symmetry and the adjusting member drives the connecting column 123 to rotate by 90°, the second baking plate 122 moves up or down by the height h relative to the second housing 121.

The adjusting member is arranged on the second housing 121 and engaged with a tail end of the second end portion of the connecting column 123 so as to control the connecting column 123 to rotate through the adjusting member, so that the second baking plate 122 drives the connecting column 123 to move up or down by a height h relative to the second housing 121. In this example, the adjusting member is a knob 125 coaxially engaged with the tail end of the second end portion of the connecting column 123.

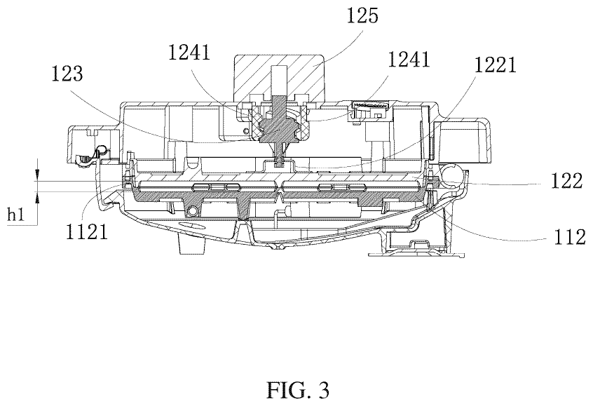

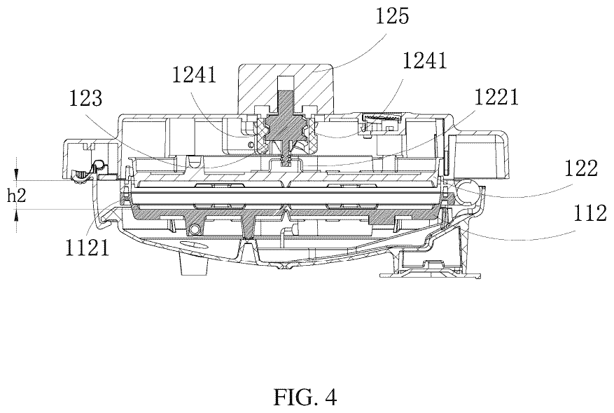

FIG. 3 and FIG. 4 are schematic views of the baking device of the present invention in which the second baking plate is moved up and down respectively. Generally, the knob 125 is fixedly connected with the connecting column 123. However, in the present invention, in order to prevent the connecting column 123 from pushing the knob 125 away from the second housing 121 or prevent the connecting column 123 from being separated from the knob 125 when moving up or down, the knob 125 includes a connecting hole. The connecting hole has a depth equal to the height h and has a same shape as a cross section of the tail end of the second end portion of the connecting column 123, and the tail end of the second end portion of the connecting column 123 is inserted into and engaged with the connecting hole.

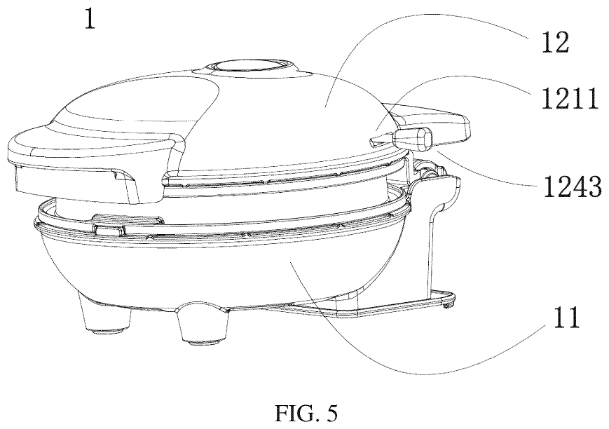

FIG. 5 shows a three-dimensional view of a baking device according to a second example of the present invention. In this example, the adjusting member is an adjusting arm 1243 extending from the connecting column 123 out of the second housing 121 along any direction, which can increase the moment of force applied, and relative side of the second housing 121 are provided with a rail grooves 1211. Preferably, the adjusting arm 1243 extends from the connecting column 123 perpendicularly out of a side of the second housing 121.

As shown in FIG. 3 and FIG. 4, the first grill unit 11 includes a first housing 111, and a first baking plate 112 fixedly mounted on an inner side of the first housing 111 and facing the second grill unit 12 so as to prevent the food from spillover. A periphery of the first baking plate 112 is provided with a side wall 1121, so that the first baking plate and the second baking plate 122 form a baking space. Preferably, a height of the side wall 1121 is equal to the height h by which the second baking plate 122 moves up or down. In this example, when the second baking plate 122 is moved down relative to the second housing 121, the distance between the second baking plate 122 and the first baking plate 112 is h1. Alternatively, when the second baking plate 122 is moved up relative to the second housing 121, the distance between the second baking plate 122 and the first baking plate 112 is h2. The height h of the side wall 1121 is the difference between the pitch h2 and the pitch h1. Preferably, the height h is 10 mm.

The above description of the specific embodiments of the present invention with reference to the accompanying drawings is only schematic, but the present invention is not limited to the above specific embodiments. Under the inspiration of the present invention, those of ordinary skill in the art can make various forms without departing from the spirit of the present invention and the scope protected by the claims, which are all within the scope of the present invention.

1. A height-adjustable baking device, comprising a first grill unit and a second grill unit pivoted to the first grill unit, the second grill unit comprising a second housing, and a second baking plate movably mounted in the second housing and facing the first grill unit, wherein
the second grill unit further comprises a connecting column and an adjusting member;
a first end portion of the connecting column is connected with the second baking plate, so that relative positions between the connecting column and the second baking plate remain unchanged;
a second end portion of the connecting column is screwed with the second housing, and the connecting column is movable relative to the second housing along a vertical rotation direction; and
the adjusting member is arranged on the second housing and engaged with a tail end of the second end portion of the connecting column so as to control the connecting column to rotate through the adjusting member, so that the connecting column drives the second baking plate to move up or down by a height relative to the second housing.

2. The height-adjustable baking device according to claim 1, wherein
the second end portion of the connecting column is screwed with the second housing through thread grooves and thread ridges.

3. The height-adjustable baking device according to claim 2, wherein
an outer surface of the second end portion of the connecting column is provided with the thread ridges; and
the second housing is provided with a fixing member forming a hollow sleeve, and an inner surface of the hollow sleeve of the fixing member is provided with the thread grooves.

4. The height-adjustable baking device according to claim 1, wherein
a side of the second baking plate facing away from the first grill unit is provided with a snap-fit member, and the first end portion of the connecting column is movably connected with the snap-fit member.

5. The height-adjustable baking device according to claim 1, wherein
the first end portion of the connecting column is fixedly connected with the second baking plate;
when a pattern on a surface of the second baking plate is in axial symmetry and the adjusting member drives the connecting column to rotate by 180°, the second baking plate moves up or down by the height relative to the second housing; and
when the pattern on the surface of the second baking plate is in central symmetry and the adjusting member drives the connecting column to rotate by 90°, the second baking plate moves up or down by the height relative to the second housing.

6. The height-adjustable baking device according to claim 1, wherein
the first grill unit comprises a first housing, and a first baking plate fixedly mounted on an inner side of the first housing and facing the second grill unit, and a periphery of the first baking plate is provided with a side wall, so that the first baking plate and the second baking plate form a baking space.

7. The height-adjustable baking device according to claim 6, wherein
a height of the side wall is equal to the height by which the second baking plate moves up or down.

8. The height-adjustable baking device according to claim 1, wherein
the adjusting member is a knob, the knob comprises a connecting hole, the connecting hole has a depth equal to the height and has a same shape as a cross section of the tail end of the second end portion of the connecting column, and the tail end of the second end portion of the connecting column is inserted into and engaged with the connecting hole.

9. The height-adjustable baking device according to claim 1, wherein
the adjusting member is an adjusting arm extending from the connecting column out of the second housing along any direction, and opposite sides of the second housing are provided with a rail groove.

10. The height-adjustable baking device according to claim 9, wherein
the adjusting arm extends from the connecting column perpendicularly out of a side of the second housing.
